(19) United States
(12) Patent Application Publication
(10) Pub. No.: US 2026/0010960 A1
(43) Pub. Date: Jan. 8, 2026

(54) SYSTEMS AND METHODS FOR AUTOMATIC POST CREATION IN SOCIAL MEDIA PLATFORMS IN A TIERED SOFTWARE FRAMEWORK

(71) Applicant: HighLevel Inc., Dallas, TX (US)

(72) Inventors: Shivani Gera, New Delhi (IN); Nilasish Pal, Asansol (IN); Ashutosh Anand, Bokaro (IN); Shaun Clark, Eugene, OR (US); Robin Alex, Dallas, TX (US); Varun Vairavan, Doha (QA)

(73) Assignee: HighLevel Inc., Dallas, TX (US)

(21) Appl. No.: 18/762,873

(22) Filed: Jul. 3, 2024

(51) Int. Cl. G06Q 50/00; G06F 40/30

(52) U.S. Cl. CPC G06Q 50/01; G06F 40/30

(57) ABSTRACT

Embodiments of a method automatic post creation in a community provisioned in a tier of a tiered software framework are disclosed. The method is executed by a software bot, and comprises monitoring interactions between community members in the community; analyzing the interactions using an artificial intelligence (AI) model to identify a sentiment trend in the interactions, the analyzing being performed in another tier of the tiered software framework; responsive to identifying the sentiment trend, automatically composing a post comprising at least text generated from a semantic analysis of the interactions, the post being in a tone corresponding to the sentiment trend; and automatically publishing the post in the community.

### TECHNICAL FIELD

The present disclosure relates to systems, techniques, and methods directed to systems and methods for automatic post creation in social media platforms in a tiered software framework.

### BACKGROUND

Artificial intelligence (AI) is a growing field in computer science that uses machine learning models to make predictions, recommendations, or classifications based on input data. Revenue from the AI software market worldwide is expected to reach 126 billion dollars by 2025 according to some estimates. In some domains, such as marketing, AI has the potential to significantly impact the delivery of marketing services using behavioral analysis, pattern recognition, and other learning algorithms.

### BRIEF DESCRIPTION OF THE DRAWINGS

Embodiments will be readily understood by the following detailed description in conjunction with the accompanying drawings. To facilitate this description, like reference numerals designate like elements. Embodiments are illustrated by way of example, and not by way of limitation, in the figures of the accompanying drawings.

FIG. 1 is a simplified block diagram illustrating an example AI bot application for automatic post creation in social media platforms in a tiered software framework, according to some embodiments.

FIG. 2 is a simplified block diagram illustrating an example embodiment of the tiered software framework.

FIG. 3 is a simplified block diagram illustrating example details of data hierarchy in the tiered software framework, according to some embodiments.

FIG. 4 is a simplified block diagram illustrating example details of the AI bot application for automatic post creation in social media platforms in a tiered software framework, according to an example embodiment.

FIG. 5 is a simplified block diagram illustrating an example configuration in AI bot application for automatic post creation in social media platforms in a tiered software framework, according to various embodiments.

FIG. 6 is a simplified block diagram illustrating another example configuration in AI bot application for automatic post creation in social media platforms in a tiered software framework, according to various embodiments.

FIG. 7 is a simplified block diagram illustrating yet another example configuration in AI bot application for automatic post creation in social media platforms in a tiered software framework, according to various embodiments.

FIGS. 8A-8B are simplified block diagrams illustrating example details of AI bot application for automatic post creation in social media platforms in a tiered software framework, according to various embodiments.

FIGS. 9A-9F are example details of a user interface in AI bot application for automatic post creation in social media platforms in a tiered software framework, according to some embodiments.

FIG. 10 is a simplified flow diagram illustrating example operations associated with AI bot application for automatic post creation in social media platforms in a tiered software framework, according to some embodiments.

FIG. 11 is a simplified flow diagram illustrating other example operations associated with AI bot application for automatic post creation in social media platforms in a tiered software framework, according to some embodiments.

FIG. 12 is a simplified flow diagram illustrating yet other example operations associated with AI bot application for automatic post creation in social media platforms in a tiered software framework, according to some embodiments.

### DETAILED DESCRIPTION

### Overview

For purposes of illustrating the embodiments described herein, it is important to understand certain terminology and operations of technology networks. The following foundational information may be viewed as a basis from which the present disclosure may be properly explained. Such information is offered for purposes of explanation only and, accordingly, should not be construed in any way to limit the broad scope of the present disclosure and its potential applications.

Online community forums, also simply called “communities” (singular form “community”) are social media platforms where people gather to discuss various topics, share information, ask questions, and engage in conversations with others who have similar interests. Typically, the communities facilitate interaction among users; users can send and reply to messages, publish (e.g., post, submit, etc.) content including text and multimedia, quote other users' posts, and review (e.g., “like” “dislike” “upvote” “downvote,” “tag” etc.) content appropriately. Some communities are organized into discussion threads or groups, where users publish messages related to specific topics. Each thread typically focuses on a single topic, allowing users to easily navigate and contribute to conversations. Some communities are divided into categories and subcategories based on different subjects or themes to help users find relevant discussions and connect with others who share their interests. Users in communities typically create profiles that include information about themselves, such as a username, avatar, and additional details such as location or interests. Profiles may also display a user's activity on the forum, such as the number of posts made or their join date, etc.

These communities and the interactions therein are moderated to ensure that discussions remain civil, respectful, and on-topic. Moderators enforce community guidelines, remove spam or inappropriate content, and help resolve conflicts between users. While most moderators currently are human, some communities implement automated bots that perform certain tasks of monitoring. For example, moderator bots continuously monitor the community for any content that violates community guidelines or terms of service. This can include spam, abusive language, hate speech, or other inappropriate content. These bots use algorithms to detect patterns in user behavior and content, flagging posts with certain keywords, detecting suspicious activity such as mass posting, or identifying accounts engaging in disruptive behavior. Typically, when the bot identifies potentially problematic content or behavior, it alerts human moderators for review. This allows human moderators to make judgment calls based on context and nuances that may be challenging for bots to understand. In some cases, moderator bots can take immediate action against content or users that violate community guidelines. This may include removing posts, issuing warnings, or temporarily suspending accounts. These actions are typically based on predefined rules and thresholds set by the community administrators (also called “admins” for short). Moderator bots may also interact with users in the forum. They can respond to common inquiries, provide guidance on community guidelines, or offer assistance in navigating the forum's features. Overall, moderator bots serve as valuable tools for human administrators, helping to streamline moderation tasks, enforce rules consistently, and create a safer and more welcoming environment for users. However, they typically work in conjunction with the human moderators who provide oversight and judgment in more complex cases.

Advanced moderator bots are sometimes configured to learn from their interactions and improve their detection accuracy over time. They may use AI to adapt to new forms of spam or abuse, making them more effective in maintaining a healthy community. In general, AI comprises machine learning models that make predictions, recommendations, and classifications. Machine learning models typically use algorithms to parse data, learn from the parsed data, and make informed decisions based on what has been learned. According to some classifications, deep learning models are subsets of machine learning models, being machine learning algorithms that operate in multiple layers, creating an artificial neural network. According to some other classifications, machine learning models are those that rely on human intervention to learn, whereas deep learning models automatically learn without human intervention. Because the learning algorithms are more relevant to the disclosure herein than any human intervention to provide training data, the former classification is employed herein, such that wherever “machine learning models” is used, it is intended that deep learning models are included as well.

Deep learning models, in particular, enable AI algorithms such as generative AI models (e.g., ChatGPT™). In a general sense, AI algorithms have three qualities that differentiate them from other algorithms: intentionality, intelligence, and adaptability. As intentional algorithms, they make decisions, often using real time data, combining information from a variety of different sources, analyzing the combined information instantly, and acting on insights derived from such data. As intelligent algorithms, they are capable of spotting patterns in underlying data. As adaptable algorithms, they learn and adapt their analyses based on shifting input data.

Recent trends in AI technology include commercially available AI engines that expose application programming interfaces (APIs) for other applications to consume. In a general sense, the API is a set of rules and protocols that defines how two software systems may communicate with each other. AI APIs allow advanced AI capabilities of the AI engine to be integrated into applications by allowing the application to make requests to the API and to receive responses. Thus, these applications provide, through the API, data to the AI engine, which runs machine learning models on the data to give suitable results as requested by the applications. Different AI engines may use different machine learning models, thereby providing different results to the same input data. Some AI engines may provide a certain functionality (e.g., text processing only) and some other AI engines may provide a certain other functionality (e.g., image processing only), while some others may provide multiple functionalities (e.g., text, speech, and image processing).

Current advances in AI have enabled diverse end-use applications of such APIs using natural language processing (NLP). One such end-use is content creation, enabling creating articles, white papers, blog posts, social media posts, etc. based on prompts provided by a human user. AI can generate written content by analyzing large datasets of text and learning the patterns and structures of language. This can include generating articles, product descriptions, reviews, or marketing copy. Mathematical algorithms such as Generative Pre-trained Transformer (GPT) models are commonly used for this purpose. AI-powered tools can automatically curate and summarize content from various sources, helping users discover relevant articles, news stories, or research papers more efficiently. These tools can analyze text, extract key information, and generate concise summaries or abstracts. Various other such functions are enabled according to the different AI algorithms employed.

In contrast to such end-uses, embodiments disclosed herein enable a method for automatic post creation in social media platforms in a tiered software framework. The tiered software framework comprises a plurality of tiers. A bot generator executing in a first tier may instantiate an AI bot at a second tier to moderate a community at the second tier. The community comprises a social media platform on which users with access credentials at a third tier can interact with each other. The AI bot may monitor interactions between the users, analyze the interactions over time to identify positive, negative or neutral sentiment trends in the interactions, and generate posts in response to the identified sentiment trends. The interactions may comprise one or more of posts, comments, messages, and reviews. In one example, the generated posts may comprise aggregated content including text and multimedia scraped from the interactions (with appropriate copyright and other permissions) and recomposed with additional original content according to the identified sentiment trends. In another example, the generated post may comprise only original content derived from analysis of the interactions.

In another embodiment, a plurality of tiers may be provided in a software framework. Data in a first tier may be accessible at the first tier and inaccessible at a second tier and a third tier, data in the second tier may be accessible at the first tier and the second tier and inaccessible at the third tier, and data in the third tier may be accessible at the first tier, the second tier and the third tier. A bot generator at the first tier may automatically create one or more instances of an AI bot to monitor a community at the second tier according to personality and functionality settings preconfigured at the second tier. The community may comprise discussion threads between users at the third tier. In one example, each discussion thread may be monitored by a separate instance of the AI bot; in another example, a plurality of discussion threads may be monitored by a single instance of the AI bot. In some examples, each discussion thread may comprise a separate group; in other examples, a single group may comprise multiple discussion threads.

In the following detailed description, various aspects of the illustrative implementations may be described using terms commonly employed by those skilled in the art to convey the substance of their work to others skilled in the art.

The term “AI bot,” as used herein, refers to a computer program or software application that operates autonomously or semi-autonomously to perform predefined tasks or functions. The AI bot may utilize artificial intelligence, machine learning, or other predetermined algorithms to analyze input data, make decisions, and execute actions without direct human intervention. The AI bot may interact with users (i.e., humans) through various interfaces, such as text-based chat interfaces, voice recognition systems, or graphical user interfaces. In some embodiments herein, the AI bot is a software object instantiated with certain configuration settings.

As used herein, the term “application” can be inclusive of an executable file comprising instructions that can be understood and processed on a computing device such as a computer, and may further include library modules loaded during execution, object files, system files, hardware logic, software logic, or any other executable modules. Applications are generally configured to perform particular tasks, or functions according to the type of application.

The term “computing device” means a server, a desktop computer, a laptop computer, a smartphone, or any device with a microprocessor, such as a central processing unit (CPU), general processing unit (GPU), or other such electronic component capable of executing processes of a software algorithm (such as a software program, code, application, macro, etc.).

The term “cloud network” means a network of computing devices coupled together in a public, private, or hybrid communications network. Communication in the cloud network may use one or more wired, wireless, broadband, radio, and other kinds of communicative means. The Internet is an example of a cloud network.

The term “connected” means a direct connection (which may be one or more of a communication, mechanical, and/or electrical connection) between the things that are connected, without any intermediary devices, while the term “coupled” means either a direct connection between the things that are connected, or an indirect connection through one or more passive or active intermediary devices.

The description uses the phrases “in an embodiment” or “in embodiments,” which may each refer to one or more of the same or different embodiments.

Although certain elements may be referred to in the singular herein, such elements may include multiple sub-elements. For example, “a computing device” may include one or more computing devices.

Unless otherwise specified, the use of the ordinal adjectives “first,” “second,” and “third,” etc., to describe a common object, merely indicate that different instances of like objects are being referred to and are not intended to imply that the objects so described must be in a given sequence, either temporally, spatially, in ranking or in any other manner.

In the following detailed description, reference is made to the accompanying drawings that form a part hereof, and in which is shown, by way of illustration, embodiments that may be practiced. It is to be understood that other embodiments may be utilized, and structural or logical changes may be made without departing from the scope of the present disclosure. Therefore, the following detailed description is not to be taken in a limiting sense.

The accompanying drawings are not necessarily drawn to scale. In the drawings, same reference numerals refer to the same or analogous elements shown so that, unless stated otherwise, explanations of an element with a given reference numeral provided in context of one of the drawings are applicable to other drawings where element with the same reference numerals may be illustrated. Further, the singular and plural forms of the labels may be used with reference numerals to denote a single one and multiple ones respectively of the same or analogous type, species, or class of element.

Note that in the figures, various components are shown as aligned, adjacent, or physically proximate merely for ease of illustration; in actuality, some or all of them may be spatially distant from each other. In addition, there may be other components, such as routers, switches, antennas, communication devices, etc. in the networks disclosed that are not shown in the figures to prevent cluttering. Systems and networks described herein may include, in addition to the elements described, other components and services, including network management and access software, connectivity services, routing services, firewall services, load balancing services, content delivery networks, virtual private networks, etc. Further, the figures are intended to show relative arrangements of the components within their systems, and, in general, such systems may include other components that are not illustrated (e.g., various electronic components related to communications functionality, electrical connectivity, etc.).

In the drawings, a particular number and arrangement of structures and components are presented for illustrative purposes and any desired number or arrangement of such structures and components may be present in various embodiments. Further, unless otherwise specified, the structures shown in the figures may take any suitable form or shape according to various design considerations, manufacturing processes, and other criteria beyond the scope of the present disclosure.

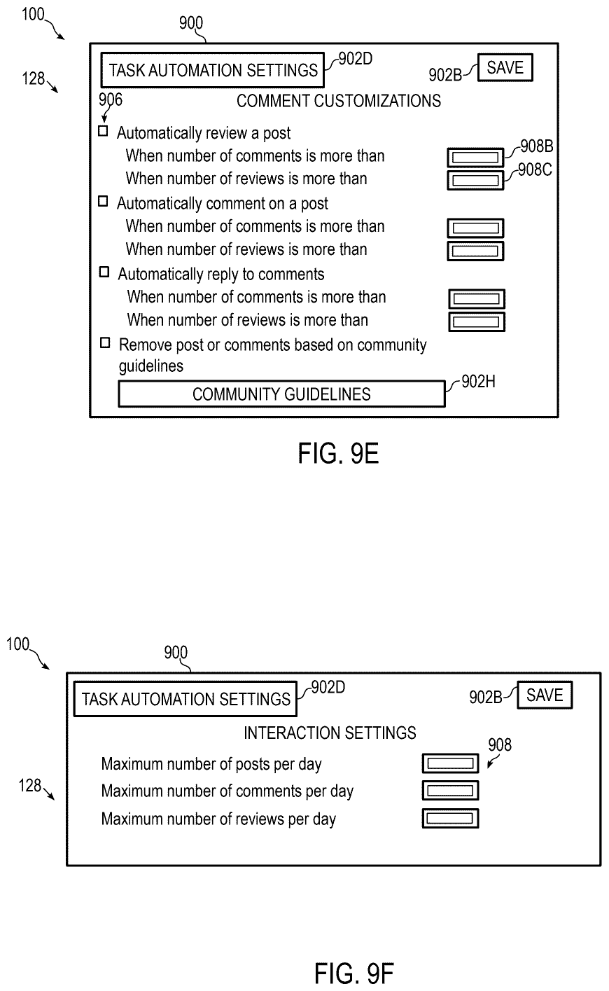

For convenience, if a collection of drawings designated with different letters are present (e.g., FIGS. 9A-9C), such a collection may be referred to herein without the letters (e.g., as “FIG. 9”). Similarly, if a collection of reference numerals designated with different letters are present (e.g., 106a, 106b), such a collection may be referred to herein without the letters (e.g., as “106”) and individual ones in the collection may be referred to herein with the letters. Further, labels in upper case in the figures (e.g., 106A) may be written using lower case in the description herein (e.g., 106a) and should be construed as referring to the same elements.

Various operations may be described as multiple discrete actions or operations in turn in a manner that is most helpful in understanding the claimed subject matter. However, the order of description should not be construed as to imply that these operations are necessarily order dependent. In particular, these operations may not be performed in the order of presentation. Operations described may be performed in a different order from the described embodiment. Various additional operations may be performed, and/or described operations may be omitted in additional embodiments.

### Example Embodiments

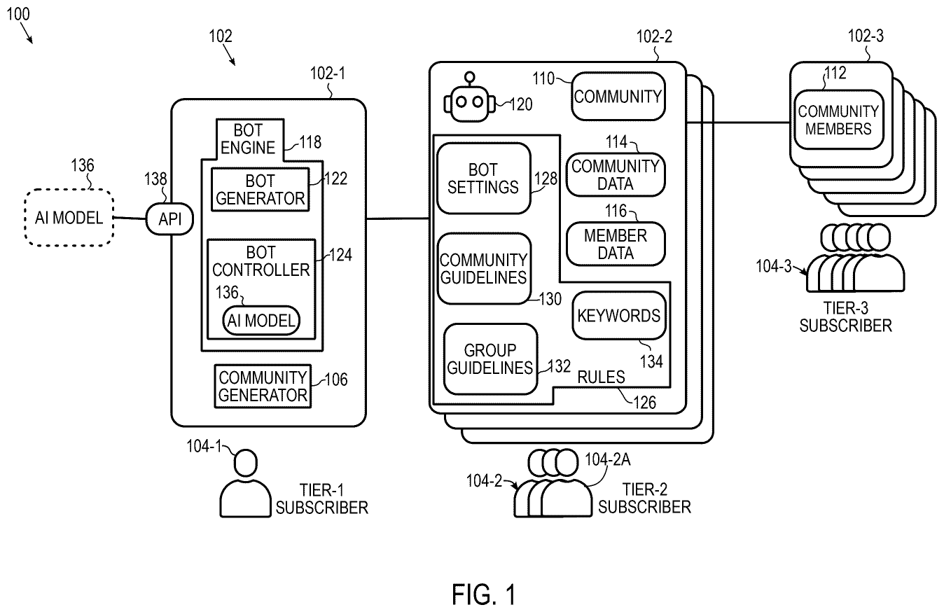

FIG. 1 is a simplified block diagram illustrating an example AI bot application 100 according to some embodiments. AI bot application 100 may comprise various tiers 102. In the example shown, AI bot application 100 has three tiers: 102-1, 102-2, and 102-3. Note that the labeling convention followed herein uses the hyphen followed by a number to denote a separate tier corresponding to the number (e.g., “-1” denotes tier-1, “-2” denotes tier-2, and “-3” denotes tier-3). Tiers 102 may be accessed by subscribers 104 according to access credentials based on their respective tiers 102. For example, subscribers 104-1 may have access to tiers 102-1, 102-2, and 102-3; subscribers 104-2 may have access to tiers 102-2 and 102-3; and subscribers 104-3 may have access only to tier 102-3.

Tiers 102 may be organized according to a hierarchy of management (i.e., to oversee, to control, to maintain), with upstream tiers managing downstream ones. Thus, tier 102-1 comprises operations that may manage tiers 102-2 and 102-3, whereas tier 102-2 comprises operations that may manage tier 102-3 but not tier 102-1. For purposes of terminology, tier 102-1 is “upstream” relative to tiers 102-2 and 102-3; tier 102-3 is “downstream” relative to tiers 102-2 and 102-1; tier 102-2 is downstream relative to tier 102-1 and upstream relative to tier 102-3. In some embodiments, each tier 102 may interact with the tier immediately adjacent thereto (e.g., downstream or upstream) but not with non-adjacent tiers. In some other embodiments, any tier 102 may interact with any other tier.

AI bot application 100 may be managed by subscriber 104-1 providing one or more downstream subscribers 104-2 at tier 102-2 with access to certain functionalities of AI bot application 100. In turn, subscriber 104-2 may provide one or more downstream subscriber 104-3 at tier 102-3 with access to certain other functionalities of AI bot application 100. In various examples, the functionalities available to subscribers 104-1 may not be the same as those available to subscribers 104-2, which may be different from those available to subscribers 104-3. Subscribers 104 (e.g., 104-1, 104-2 and 104-2) may include an entity (i.e., a company, an organization, etc.) in various embodiments. In an example embodiment, subscribers 104-1 may be software-as-a-service (Saas) providers, subscribers 104-2 may comprise marketing agencies, and subscribers 104-3 may comprise individual businesses, such as plumbers, dentists, pet stores, etc.

Human users at subscribers 104 may operate or otherwise use AI bot application 100 through one or more devices such as computers, laptops, smartphones, mobile computing devices, mobile phones, iPads™, Google Droids™, Microsoft® Surface™, etc. In various embodiments, a single subscriber 104-1 may have multiple subscribers 104-2 at tier 102-2; a single subscriber 104-2 at tier 102-2 may have multiple subscribers 104-3 at tier 102-3. Each subscriber 104-2 may have an account with one subscriber 104-1 at tier 102-1; each subscriber 104-3 may have an account with one subscriber 104-2 at tier 102-2. In other words, there may be a one-to-many relationship downstream (e.g., from tier-1 to tier-2 to tier-3), and a one-to-one relationship upstream (e.g., from tier-3 to tier-2 to tier-1).

In various embodiments, AI bot application 100 may include a community generator 106 at tier 102-1. Community generator 106 may generate a community 110 in tier 102-2. In an example embodiment, community 110 is a social media platform (e.g., social network, virtual community, community forum, forum, discussion board, discussion platform, messaging app, online network, online platform, interest group, online society, etc.) in which one or more community members 112 interact with each other. In an example, a marketing agency, being one of subscribers 104-2, may decide to support community 110 in their account, and the marketing agency's customers, namely a subset of subscribers 104-3 as represented by community members 112, may join community 110. Note that community members 112 are users of AI bot application 100; examples of community members 112 include employees, owners or customers of subscribers 104-3 or 104-2 who have access credentials to join community 110. Community generator 106 may generate community 110 accordingly, allowing for creation of groups, discussion threads, etc. according to specifications and/or formats specified by subscriber 104-2. In some embodiments, each account at tier 102-2 may host a separate instance of community 110.

Different accounts at tier 102-2 may have correspondingly different specifications and/or formats for respective ones of community 110. Examples of specifications and/or formats include the number of groups allowed in community 110, the number of members allowed in each group, post format (e.g., article, one paragraph, emoji allowed, etc.), message format (e.g., chat, discussion thread, etc.), review format (e.g., like, dislike, upvote, downvote, etc.), awards (e.g., badges, tokens, etc.), etc. Data associated with community 110 may be stored as community data 114 at tier 102-2. Community data 114 may include archived chats, posts, reviews, messages, analysis data, etc. associated with a predetermined period. Community members 112 may provide data to join community 110, such as name, age, location, occupation, interests, copyright permissions, privacy permission, cookie permissions, group membership, etc. Such data may be stored at tier 102-2 as member data 116.

AI bot application 100 may further include a bot engine 118 that instantiates and controls an AI bot 120 in tier 102-2 to automatically monitor community 110, among other functions. A bot generator 122 in bot engine 118 may instantiate AI bot 120 and deploy AI bot 120 to community 110. Bot generator 122 may provision AI bot 120 with certain functionalities, such as monitoring interactions in community 110, analyzing the interactions, publish its own interactions, etc. Thereafter, AI bot 120 may appear as another user (e.g., administrator, moderator) to community members 112 in community 110. A bot controller 124 in bot engine 118 may control the functionalities of AI bot 120 according to rules 126 configured at tier 102-2. For example, various functionalities of AI bot 120 may be provisioned by bot generator 122, while various parameters of these functionalities may be selected or fixed at tier 102-2 according to rules 126 (e.g., AI bot 120 may be able to “like” a comment based on provisioning by bot generator 122; rules 126 may specify that AI bot 120 may “like” a comment only if the number of comments exceeds a minimum threshold). In some embodiments, the controlling may be performed in view of ongoing activities in community 110, community data 114 and member data 116.

Some actions by AI bot 120 may be performed in community 110 in tier 102-2 and other actions by AI bot 120 may be performed in bot engine 118 in tier 102-1. AI bot 120 may thus straddle tiers 102-1 and 102-2, while also being visible (and configurable) to an administrator in tier 102-2 and to another administrator at tier 102-1, based on particular needs. Rules 126 may include bot settings 128, community guidelines 130, group guidelines 132, and keywords 134. Such rules 126 may be preconfigured by subscriber 104-2 in whose account community 110 is hosted. Different accounts in tier 102-2 may specify different rules 126. In some embodiments, AI bot 120 may be configured to act when all rules 126 are met; in other embodiments, AI bot 120 may be configured to act when a subset of rules 126 is met.

In some embodiments, bot settings 128 may specify rules for actions initiated by AI bot 120, among other functions. Administrators at tier 102-2 may configure bot settings 128 to include topics and conditions for automatic posts, enable custom messages based on different sentiment levels or specific events, configure custom welcome messages for new members, and store predefined responses to common queries and interactions. Bot settings 128 may specify that AI bot 120 may automatically comment on posts that reach a certain level of engagement (e.g., exceeding a minimum number of comments or reviews); automatically reply to comments if a post or comment reaches a predefined engagement threshold; automatically delete posts that exceed a certain number of negative reactions or fail to meet community guidelines based on engagement metrics; etc.

Other examples of bot settings 128 include trigger events, such as new posts, keywords in messages, new tags, new mentions, new incoming direct message, keywords in comments, etc. For example, AI bot 120 may be configured to respond to new posts based on the post's content or metadata; submit a review or comment based on keywords identified in messages or comments; respond when a specific tag is used in a post or comment; respond when AI bot 120 or a specific user is mentioned or tagged; respond when an administrator gets a direct message; etc. Yet other examples of bot settings 128 include frequency of interactions, such as minimum number of posts per day; maximum number of comments per day; maximum number of reviews per day; and so on. Bot settings 128 may configure AI bot 120 to suggest relevant articles, videos, or documents based on member interests or queries; and highlight and pin trending topics or popular discussions within community 110 or groups therein. In various embodiments, AI bot 120 may be configured to send warnings to users who violate community guidelines 130 or group guidelines 132, analyze member behavior to identify potential issues before they escalate and monitor for specific keywords 134 to catch problems early. AI bot 120 may also analyze various interactions, and provide detailed metrics on member engagement, activity patterns, and content performance.

Community guidelines 130 may specify interaction rules, topics or themes that are off-limits, topics that are favored, number of groups that may be created, who can create groups, etc. Another example of community guideline 130 may specify that content from an interaction may be scraped and re-used in posts by AI bot 120 only with permission from relevant one of community members 112. Group guidelines 132 may specify further rules for each group, such as topics, themes, etc. Keywords 134 may specify a list of words that may trigger certain actions by AI bot 120. Bot controller 124 may also continuously monitor the performance of AI bot 120, gather feedback from users, and bot generator 122 may implement updates and improvements to AI bot 120 based on user feedback and performance metrics.

During operations, AI bot 120 may monitor interactions within the community, such as posts, comments, reviews, etc. as well as third-party sites (e.g., online news sources), for example, to catch up on any breaking stories or developments. AI bot 120 may analyze posts, comments, reviews etc. according to rules 126 in view of community data 114 and member data 116. AI bot 120 may further identify sentiments from the analysis of the interactions and generate its own posts, comments, messages and/or reviews based on the identified sentiments. In some embodiments, AI bot 120 may gather information on preconfigured topics or potential for new topics with a view to generate suitable posts or comments. AI bot 120 may generate posts according to community and/or group guidelines, send posts to a human reviewer based on review rules, finalize posts, including by adding multimedia elements, such as photos or videos, and formatting suitably according to community guidelines 130 and/or group guidelines 132. AI bot 120 may publish posts in community 110, and thereafter respond to comments and reviews thereto appropriately.

In some embodiments, bot controller 124 may interface with an AI model 136 to perform the analysis and other actions by AI bot 120. For example, AI model 136 may facilitate semantic analysis and sentiment analysis of the interactions in community 110. In some embodiments, AI model 136 may be internally provisioned in tier 102-1; in other embodiments, AI model 136 may be external to AI bot application 100 and accessed via an API 138. In some embodiments, certain ones of AI model 136 may be internally provisioned in tier 102-1 and certain other ones of AI model 136 may be accessed via API 138. Examples of AI model 136 include NLP (e.g., OpenAI™ GPT-4, Google™ Dialogflow™), and machine learning algorithms for moderation and analytics (e.g., TensorFlow™, PyTorch™). Various other AI algorithms may be included in AI model 136 within the broad scope of the embodiments.

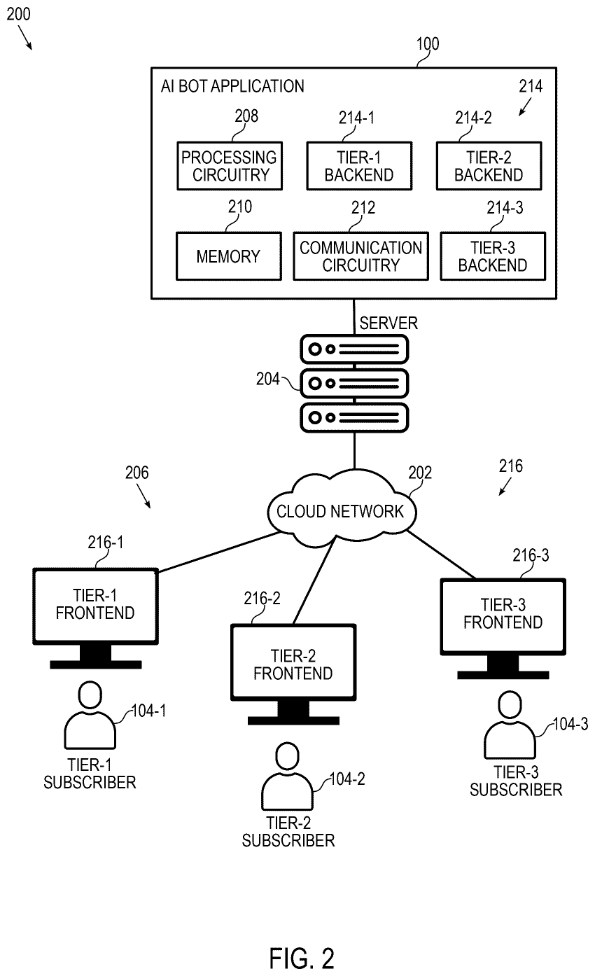

FIG. 2 is a simplified block diagram illustrating a tiered software framework 200 according to various embodiments. In example implementations, at least some portions of the activities outlined herein may be hosted on a cloud network 202 in one or more servers 204. At least some other portions of the activities outlined herein may be implemented in one or more computing devices 206 connected over one or more communication networks with cloud network 202. In particular embodiments, cloud network 202 is a collection of hardware devices and executable software forming a shared pool of configurable computing resources (e.g., networks, servers, storage, applications, services, etc.) that may be suitably provisioned to provide on-demand self-service, network access, resource pooling, elasticity and measured service, among other features. Computing device 206 may have any desired form factor, such as a handheld or mobile computing device (e.g., a cell phone, a smart phone, a mobile Internet device, a tablet computer, a laptop computer, a netbook computer, an ultra-book computer, a Personal Digital Assistant (PDA), an ultramobile personal computer, etc.), a desktop computing device, a server or other networked computing component, a set-top box, an entertainment control unit, or a wearable computing device.

Certain portions of tiered software framework 200 (e.g., AI bot application 100) may execute using a processing circuitry 208, a memory 210 and communication circuitry 212 (among other components) in one or more servers 204. Certain other portions of tiered software framework 200 may execute in one or more computing devices 206 using respective processing circuitry, memory, and communication circuitry (not shown with particularity so as not to clutter the drawing) substantially similar in functionalities to processing circuitry 208, memory 210 and communication circuitry 212. In some embodiments, one or more of these features may be implemented in hardware, provided external to these elements, or consolidated in any appropriate manner to achieve the intended functionality. The various network elements in tiered software framework 200 may include communication software that can coordinate to achieve the operations as outlined herein. In still other embodiments, these elements may include any suitable algorithms, hardware, software, components, modules, interfaces, or objects that facilitate the operations thereof.

Processing circuitry 208 may execute any type of instructions associated with data stored in memory 210 to achieve the operations detailed herein. In one example, processing circuitry 208 may transform data from one state or thing to another state or thing. In another example, the activities outlined herein may be implemented with fixed logic or programmable logic (e.g., software/computer instructions executed by a processor) and the elements identified herein could be some type of a programmable processor, programmable digital logic (e.g., field programmable gate array (FPGA), an erasable programmable read only memory (EPROM), an application specific integrated circuit (ASIC)) that includes digital logic, software, code, electronic instructions, flash memory, optical disks, magnetic or optical cards, other types of machine-readable mediums suitable for storing electronic instructions, or any suitable combination thereof.

In some of example embodiments, one or more memory 210 may store data used for the operations described herein. This includes memory 210 storing instructions (e.g., software, logic, code, etc.) in non-transitory media (e.g., random access memory (RAM), read only memory (ROM), FPGA, EPROM, etc.) such that the instructions are executed to carry out the activities described in this disclosure based on particular needs. In some embodiments, memory 210 may comprise non-transitory computer-readable media, including one or more memory devices such as volatile memory such as dynamic RAM (DRAM), nonvolatile memory (e.g., ROM), flash memory, solid-state memory, and/or a hard drive. In some embodiments, memory 210 may share a die with processing circuitry 208. Memory 210 may include algorithms, code, software modules, and applications, which may be executed by processing circuitry 208. The data being tracked, sent, received, or stored in tiered software framework 200 may be provided in any database, register, table, cache, queue, control list, or storage structure, based on particular needs and implementations, all of which could be referenced in any suitable timeframe.

Communication circuitry 212 may be configured for managing wired or wireless communications for the transfer of data in tiered software framework 200. The term “wireless” and its derivatives may be used to describe circuits, devices, systems, methods, techniques, communications channels, etc., that may communicate data through modulated electromagnetic radiation in a nonsolid medium. The term does not imply that the associated devices do not contain any wires, although in some embodiments they might not. Communication circuitry 212 may implement any of a number of wireless standards or protocols, including but not limited to Institute for Electrical and Electronic Engineers (IEEE) standards including Wi-Fi (IEEE 802.11 family), IEEE 802.16 standards (e.g., IEEE 802.16-2005 Amendment), Long Term Evolution (LTE) project along with any amendments, updates, and/or revisions (e.g., advanced LTE project, ultramobile broadband (UMB) project (also referred to as “3GPP2”), etc.). Communication circuitry 212 may operate in accordance with a Global System for Mobile Communication (GSM), General Packet Radio Service (GPRS), Universal Mobile Telecommunications System (UMTS), High-Speed Packet Access (HSPA), Evolved HSPA (E-HSPA), or LTE network. Communication circuitry 212 may operate in accordance with Enhanced Data for GSM Evolution (EDGE), GSM EDGE Radio Access Network (GERAN), Universal Terrestrial Radio Access Network (UTRAN), or Evolved UTRAN (E-UTRAN). Communication circuitry 212 may operate in accordance with Code Division Multiple Access (CDMA), Time Division Multiple Access (TDMA), Digital Enhanced Cordless Telecommunications (DECT), Evolution-Data Optimized (EV-DO), and derivatives thereof, as well as any other wireless protocols that are designated as 3G, 4G, 5G, and beyond. Communication circuitry 212 may operate in accordance with other wireless protocols in other embodiments. Communication circuitry 212 may include antennas to facilitate wireless communications and/or to receive other wireless communications.

In some embodiments, communication circuitry 212 may manage wired communications, such as electrical, optical, or any other suitable communication protocols (e.g., the Ethernet, Internet). Communication circuitry 212 may include multiple communication chips. For instance, a first communication chip may be dedicated to shorter-range wireless communications such as Wi-Fi or Bluetooth, and a second communication chip may be dedicated to longer-range wireless communications such as global positioning system (GPS), EDGE, GPRS, CDMA, WiMAX, LTE, EV-DO, or others. In some embodiments, a first communication chip may be dedicated to wireless communications, and a second communication chip may be dedicated to wired communications.

The example network environment may be configured over a physical infrastructure that may include one or more networks and, further, may be configured in any form including, but not limited to, local area networks (LANs), wireless local area networks (WLANs), virtual local area networks (VLANs), metropolitan area networks (MANs), wide area networks (WANs), virtual private networks (VPNs), Intranet, Extranet, any other appropriate architecture or system, or any combination thereof that facilitates communications in a network. In some embodiments, a communication link may represent any electronic link supporting a LAN environment such as, for example, cable, Ethernet, wireless technologies (e.g., IEEE 802.11x), ATM, fiber optics, etc. or any suitable combination thereof. In other embodiments, communication links may represent a remote connection through any appropriate medium (e.g., digital subscriber lines (DSL), telephone lines, T1 lines, T3 lines, wireless, satellite, fiber optics, cable, Ethernet, etc. or any combination thereof) and/or through any additional networks such as a WANs (e.g., the Internet).

In various embodiments, tiers 102 may be partitioned into a backend 214 and a frontend 216. Backend 214 may comprise tier-1 backend 214-1, tier-2 backend 214-2, and tier-3 backend 214-3 provisioned in one or more servers 204. Likewise, frontend 216 may comprise tier-1 frontend 216-1, tier-2 frontend 216-2, and tier-3 frontend 216-3 provisioned in one or more computing devices 206. Backend 214 may comprise various modules, logic, software engines and other components that are distributed (and common) across all users of tiered software framework 200. Backend 214 may execute operations for managing and processing data, performing computations, and facilitating communication between different components, such as components of AI bot application 100. In particular embodiments, backend 214 may include operations such as data management, business logic (e.g., AI bot application 100), user authentication and authorization, security and validation, APIs with third-party components such as web crawlers, payment processors, etc.

In a general sense, frontend 216 comprises at least a user interface using which human users interact with tiered software framework 200. Frontend 216 may also include libraries, forms, device integrators and other components as desired and based on particular needs. Frontend 216 may be presented on a suitable display device coupled to computing device 206 and appropriate to show visual indicators, such as a heads-up display, a computer monitor, a projector, a touchscreen display, a liquid crystal display (LCD), a light-emitting diode display, and/or a flat panel display. In various embodiments, frontend 216 may be specific to the particular one of tier 102. For example, frontend 216-1 at tier-1 may comprise certain functionalities available (and visible) only to subscriber 104-1, e.g., SaaS provider, software developer. Frontend 216-2 at tier-2 may comprise certain functionalities available (and visible) only to tier-2 subscriber 104-2. Frontend 216-3 at tier-3 may comprise certain functionalities available (and visible) only to tier-3 subscriber 104-3.

In various embodiments, frontend 216-2 may include an administrator (shortened to “admin”) interface using which subscriber 104-2 may configure AI bot 120 with rules 126. Frontend 216-2 may comprise a user-friendly dashboard using which admins can customize bot settings 128, for example, selecting personality settings from among a list of options to define the bot's personality traits and response style. The user interface/dashboard may allow admins to enable or disable specific bot functions.

Tiered software framework 200 described and shown herein (and/or its associated structures) may also include suitable interfaces for receiving, transmitting, and/or otherwise communicating data or information in a network environment. In a general sense, the arrangements depicted in the figures may be more logical in their representations, whereas a physical architecture may include various permutations, combinations, and/or hybrids of these elements. It is imperative to note that countless possible design configurations can be used to achieve the operational objectives outlined here. Accordingly, the associated infrastructure has a myriad of substitute arrangements, design choices, device possibilities, hardware configurations, software implementations, equipment options, etc.

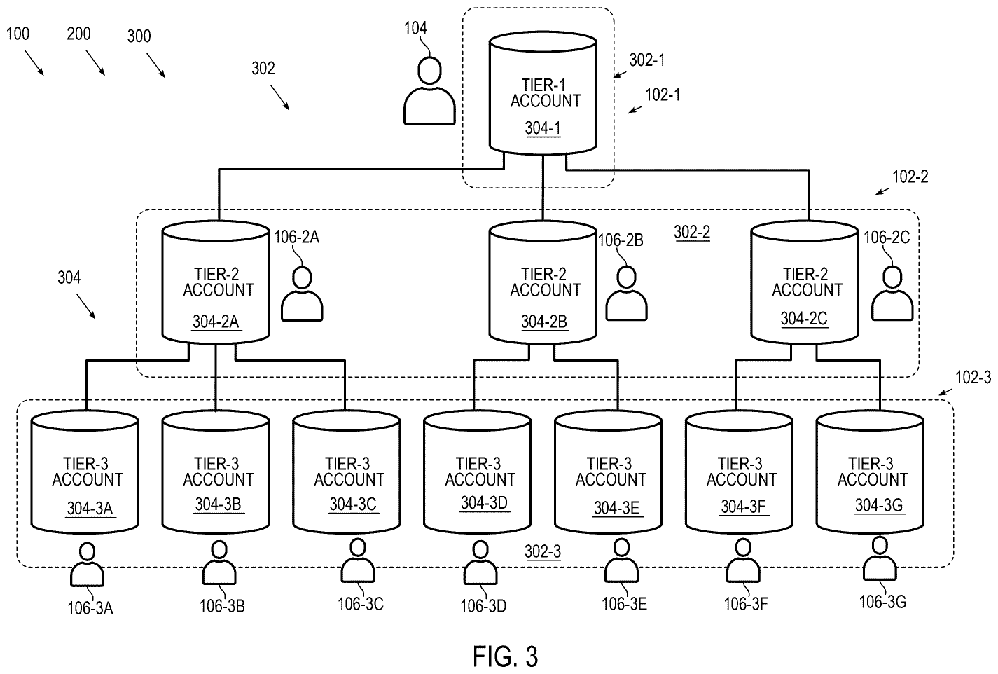

FIG. 3 is a simplified block diagram illustrating example details of data hierarchy 300 of tiered software framework 200 implementing AI bot application 100, according to some embodiments. In various embodiments, data 302 communicated in tiered software framework 200 may be exclusively received from users such as subscriber 104-1 and subscribers 104-2, and 104-3; in some other embodiments, data 302 may also be received from other sources, such as third parties and/or from the Internet. Examples of data 302 include business niche targeted by subscribers 104, marketing activities such as on social media, target audience of subscribers 104, login credentials to access various marketing platforms, frequency of marketing activities, information to be included in the content of marketing posts, customer lists, business locations, marketing platform rules, and other such data relevant to the functionalities offered by tiered software framework 200. Data 302 may be stored in data lakes, databases, data warehouses, blockchains, file systems and other types of data storage facilities within the broad scope of the embodiments with corresponding accessing and viewing capabilities as described herein. In various embodiments, community data 114 and member data 116 may be subsets of data 302.

Data 302 in each tier 102 may be contained within accounts 304 accessible and viewable with appropriate access credentials. For example, account 304-1 may be associated with subscriber 104-1. Account 304-1 may manage a plurality of accounts 304-2 at tier 102-2. Subscriber 104-2a may have a subscription to account 304-2a in plurality of accounts 304-2. Account 304-2a may manage a plurality of accounts 304-3 at tier 102-3. Subscriber 104-3a may have a subscription to account 304-3a in plurality of accounts 304-3; subscriber 104-3b may have a subscription to account 304-3b in plurality of accounts 304-3; and subscriber 104-3c may have a subscription to account 304-3c in plurality of accounts 304-3. In other words, subscriber 104-2a has three downstream subscribers at tier 102-3, namely subscribers 104-3a, 104-3b, and 104-3c with their associated respective accounts 304-3a, 304-3b, and 304-3c. Likewise for other accounts shown in the figure. Note that such a framework is merely provided for illustrative purposes and should not be construed as a limitation. Any number of subscribers may be provided at tiers 102-2 and 102-3 in tiered software framework 200 within the broad scope of the embodiments.

In various embodiments, data 302 may be arranged in data hierarchy 300 for different accounts 304 such that certain users can view and access only a subset of data 302 according to their respective tier 102 and access credentials based on particular needs (e.g., user credentials may indicate which tier 102 and which corresponding accounts 304 are available for access and view). Such accounts 304 may be facilitated by a suitable user interface at frontend 216 for viewing the accessible data. Appropriate user authentication and authorization engines running in backend 214 may ensure that accounts 304 are maintained as desired and appropriate privacy blocks are applied at appropriate tiers 102.

In the example illustrated herein, tier-1 data 302-1 may be of account 304-1; tier-2 data 302-2 may be of accounts 304-2a, 304-2b and 304-2c corresponding to subscribers 104-2a, 104-2b and 104-2c, respectively; tier-3 data 302-3 may be of accounts 304-3a . . . 304-3g corresponding to subscribers 104-3a . . . 104-3g. Subscribers 104-3a . . . 104-3g may access and view their own respective accounts 304-3a . . . 304-3g; however, they cannot access or view other accounts 304 in the same tier 102-3 or in upstream tiers 102-2 or 102-1. Note that accessing and viewing an account refers to accessing and viewing the data of the account. Subscribers 104-2a . . . 104-2c at tier 102-3 may access and view their own respective accounts 304-2a . . . 304-2c as well as downstream accounts 304-3 of their respective subscribers 104-3; however, they cannot access or view other accounts 304-2 in the same tier 102-2, or in downstream tier 102-3 not associated with their downstream subscribers 104-3, or in upstream tier 102-1. For example, subscriber 104-2a may access and view accounts 304-2a, 304-3a, 304-3b, and 304-3c; subscriber 104-2b may access and view accounts 304-2b, 304-3d, and 304-3e; subscriber 104-2c may access and view accounts 304-2c, 304-3f, and 304-3g. Subscriber 104-1 at tier 102-1 may access and view accounts 304-1 at tier 102-1, accounts 304-2a . . . 304-2c at tier 102-2, and accounts 304-3a . . . 304-3g at tier 102-3.

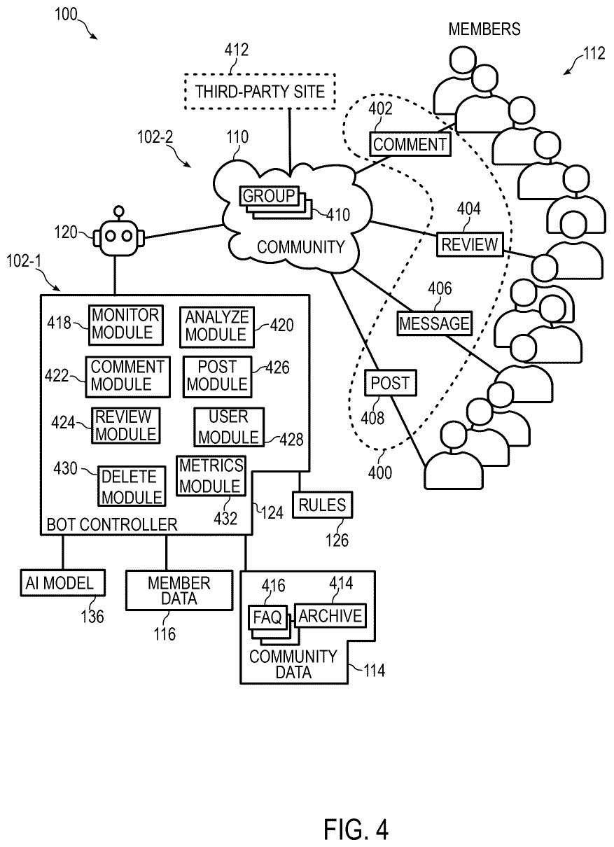

FIG. 4 is a simplified block diagram illustrating example details of AI bot application 100 according to an example embodiment. Community 110 may be provisioned in tier 102-2 of tiered software framework 200. Community members 112 may publish various interactions 400 comprising one or more of comment 402, review 404, message 406 and post 408 in one or more of group 410 in community 110. Some such interactions 400 may refer to one or more of third-party site 412. Group 410 may comprise discussion threads, or subsets of community members 112 grouped according to interests, or topics, or themes. Various other configurations for group 410 are included without departing from the scope of the embodiments. AI bot 120 may monitor interactions 400 and perform various actions based thereon in view of community data 114, member data 116, rules 126, and information gleaned from any referenced third-party site 412. Community data 114 may include archive 414, from which certain data may be extracted or tagged appropriately into various categories such as frequently asked questions (FAQ) 416, or highest rated, or most viewed, or most shared, etc., for ease of retrieval at a later date.

AI bot 120 may be controlled by bot controller 124. At least some actions by AI bot 120 may be performed in tier 102-1 of tiered software framework 200 (e.g., in bot controller 124) and certain other actions may be performed in tier 102-2 (e.g., in community 110). Monitor module 418 may monitor (e.g., observe, watch, track, etc.) interactions 400. Monitoring may comprise scraping data from interactions 400, and temporarily storing the scraped data in cache. Scraping comprises running a scraping program, which parses interactions 400 to identify relevant elements such as text, images, and reviews and extracts relevant information therefrom. The scraping program may be in various programming languages using different libraries based on particular needs (e.g., Python™, using libraries such as BeautifulSoup™, Scrapy™; Node.js™ with libraries such as Cheerio™; Ruby™ with libraries such Nokogiri™; etc.).

Analyze module 420 may perform analysis of interactions 400 suitably using AI model 136 as appropriate. The analysis may comprise textual processing (e.g., identifying words, sentences, etc.); image processing (e.g., identifying elements and features within static or moving images); semantic analysis (e.g., identifying context and meaning of words, images, etc.); permission analysis (e.g., determining whether copyright and other permissions for re-using content have been given by user); statistical analysis (e.g., counting, averaging, etc.); data analysis (e.g., identifying trends, etc.); rules filtering; and various other analysis as appropriate based on particular needs and/or rules 126.

In various embodiments, analyze module 420 may perform various types of analysis. For example, analyze module 420 may perform sentiment analysis, which is an NLP technique that identifies the sentiment expressed in text or images of interactions 400. It involves analyzing emotions, opinions, or attitudes conveyed within the text or images and categorizing them as positive, negative, or neutral. The sentiment analysis may understand the overall sentiment of a piece of text or an image in interactions 400, or the sentiment expressed towards a particular topic, product, service, or event. Sentiment analysis may be performed in different embodiments using various techniques, including machine learning algorithms (e.g., recurrent neural networks (RNNs) and convolutional neural networks (CNNs)), lexicon-based approaches, and hybrid methods combining both.

In an example embodiment, the analysis may identify a sentiment trend in interactions 400. For example, post 408 may comprise information about an upcoming discount sale at a local supermarket. Analysis of comment 402 and review 404 may indicate that a majority of community members 112 are excited about the upcoming discount sale, indicating a positive sentiment trend. In another example, message 406 in a discussion thread among community members 112 may indicate large-scale flooding in a local community. Analysis of other ones of message 406 in the discussion thread may indicate that community members 112 in the discussion thread are saddened by the news of flooding, indicating a negative sentiment trend. In yet another example, interactions 400 associated with a product may suggest neither positive nor negative ratings, suggesting a neutral sentiment trend. Various other examples are contemplated within the broad scope of the embodiments.

Based on the analysis, comment module 422 may suitably compose comment 402 to submit in appropriate group 410 in community 110; review module 424 may suitably generate review 404 for a particular one of interactions 400 and submit it appropriately (e.g., a particular person may be identified and tagged appropriately in post 408; a congratulatory comment may be “liked”; etc.); post module 426 may suitably publish post 408 that may be predicted to be of interest to community members 112 in group 410. In some embodiments, AI bot 120 may analyze the sentiment of interactions 400 in community 110 to determine the overall mood; post 408 may be automatically triggered in response to positive, negative, or neutral sentiment trends. Post 408 may also be automatically composed and published based on specific topics at scheduled intervals or based on certain triggers such as requests for information in one or more comment 402, message 406, or post 408, etc. In some embodiments, AI bot 120 may publish post 408 to keep community members 112 informed and engaged with relevant content. For example, a particular group 410 may be focused on upskilling techniques. Bot settings 128 may be configured to enable AI bot 120 to publish post 408 biweekly, with the content based on information from one or more third-party site 412 or AI training data.

In some embodiments, user module 428 may remove or add one or more community members 112 based on community guidelines 130, group guidelines 132, etc.; delete module 430 may delete any inappropriate comment 402 or post 408 based on determining that one or more of community guidelines 130 and/or group guidelines 132 is violated. In some embodiments, community members 112 may be permitted to submit reports about inappropriate content or behavior that violate community guidelines 130 or group guidelines 132, or other permissions (e.g., privacy violations, copyright permissions, etc.). AI bot 120 may analyze the content of the reports using NLP to determine the severity and validity of the allegations. User module 428 may automatically revoke access for users who violate guidelines based on the report analysis. In some embodiments, delete module 430 may delete the offending content as appropriate.

A metrics module 432 may analyze interactions 400 for marketing data, member engagement, or other metrics of interest. For example, metrics module 432 may analyze and provide detailed metrics on member engagement, activity patterns and content performance over a predetermined time period. Appropriate graphs and other pictorial representations of the data analysis may also be generated according to bot settings 128.

In various embodiments, actions by AI bot 120 may be informed by bot settings 128 in rules 126 that specify a bot personality, such as “humorous,” “casual,” “professional,” etc. Bot actions may be regulated by other bot settings 128, such as content generation settings (e.g., rules that trigger actions based on interactions 400, topics to cover, etc.), command customizations (e.g., custom messages, greeting messages, etc.); interaction settings (e.g., rules that trigger interactions 400 by AI bot 120, etc.). The tone of any content generated by AI bot 120 may be according to the preconfigured personality.

In an example scenario, one of group 410, say 410a (not shown separately), in community 110 is focused on career upskilling topics. Note that reference labels are not separated into individual ones A, B, C, etc. so as not to crowd the drawing, and are provided here for an explanatory purpose. One of community members 112, say 112a (not shown separately), publishes post 408a in group 410a about a job promotion they just achieved. In response to post 408a, many ones of community members 112 who are members of group 410 may submit one or more of congratulatory comment 402a and positive review 404a. A particular one of comment 402, say 402b (not shown separately), may be derogatory and inappropriate. Another one of comment 402, say 402c, may be from one of community members 112, say 112b (not shown separately), who is not a member of group 410a. Yet another comment 402, say 402c (not shown separately), may be related to a different topic that is typically discussed in another one of group 410, say group 410b (not shown separately). Monitor module 418 may cause AI bot 120 to monitor interactions 400. Analyze module 420 may enable AI bot 120 to analyze one or more of post 408a, comment 402a and review 404a and identify the sentiment trend as positive. Responsive to the identification, comment module 422 may enable AI bot 120, which is preconfigured with a “casual” personality, to publish a casual congratulatory message with emojis in comment 402d (not shown separately) as a reply to post 408a, and review module 424 may enable AI bot 120 to submit a “like” review 404b (not shown separately) according to the “casual” personality in bot settings 128.

Delete module 430 may enable AI bot 120 to delete the derogatory and inappropriate comment 402b. User module 428 may enable AI bot 120 to identify community member 112b as not belonging to group 410 based on member data 116 and send a private message 406 to community member 112b inquiring if they would like to join group 410a, otherwise their comment 402c would be deleted according to group guidelines 132. Responsive to the reply from community member 112b, AI bot 120 may take appropriate action, by either deleting comment 402c using delete module 430, or adding community member 112b to group 410a using user module 428. Adding community member 112b may involve changing member data 116 of community member 112b suitably to indicate addition to group 410a. AI bot 120 may analyze comment 402c, identify group 410b as the more appropriate venue for the discussion, and automatically move comment 402c to group 410 based on rules 126. Various other such actions may be performed by AI bot 120 based on particular needs.

In another example scenario, AI bot 120 may identify one of message 406, say message 406e, as asking a question. Analyze module 420 may enable AI bot 120 to parse FAQ 416 to determine whether the question has been asked and answered previously. If so, comment module 422 may enable AI bot 120 to respond to message 406e with the appropriate answer gathered from FAQ 416. In yet another scenario, AI bot 120 may identify a question as being asked repeatedly and when the number of repetitions exceeds a particular threshold, the question may be added to FAQ 416. Various other such actions may be performed by AI bot 120 based on particular needs.

In yet another example scenario, AI bot 120 may determine, from member data 116, that a particular one of community members 112, say 112e, has a birthday on a particular date. Based on rules 126, post module 426 may compose a post, say post 408f, wishing community member 112e a happy birthday and publish it in community 110 on the particular date. AI bot 120 may also provide suggestions to other ones of community members 112 to wish community member 112e a happy birthday, the suggestions provided on date previous to the particular date or on the particular date based on rules 126. Various other such actions may be performed by AI bot 120 based on particular needs. Note that although only a limited number of examples are provided herein, myriad other variations are included with in the broad scope of the embodiments of AI bot application 100.

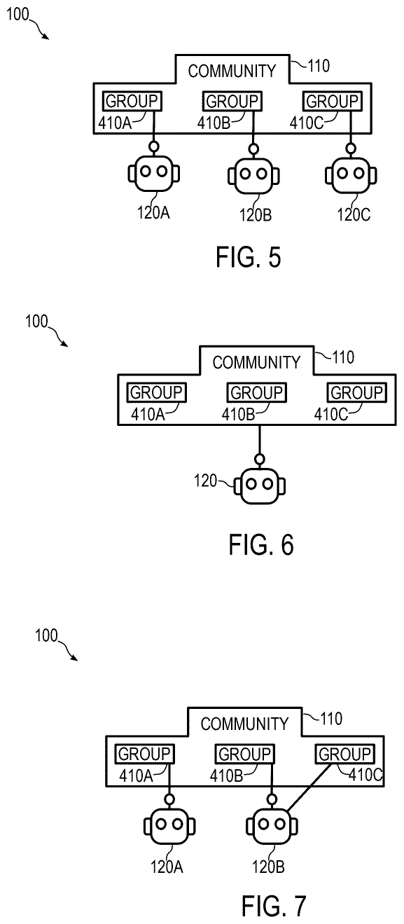

FIG. 5 is a simplified block diagram illustrating an example configuration in AI bot application 100, according to various embodiments. Community 110 may include more than one group 410, say 410a, 410b and 410c. In the example shown, each group 410a-410c is monitored by a separate instance of AI bot 120, say 120a-120c, respectively. Each instance of AI bot 120 may be separate and independent from each other in some examples; in other examples, bots 120a-120c may interact with each other as needed and based on particular configurations in rules 126. Each instance of AI bot 120 may have separate bot settings 128, for example, different names, personalities, etc. and may also have different rules 126 for actions.

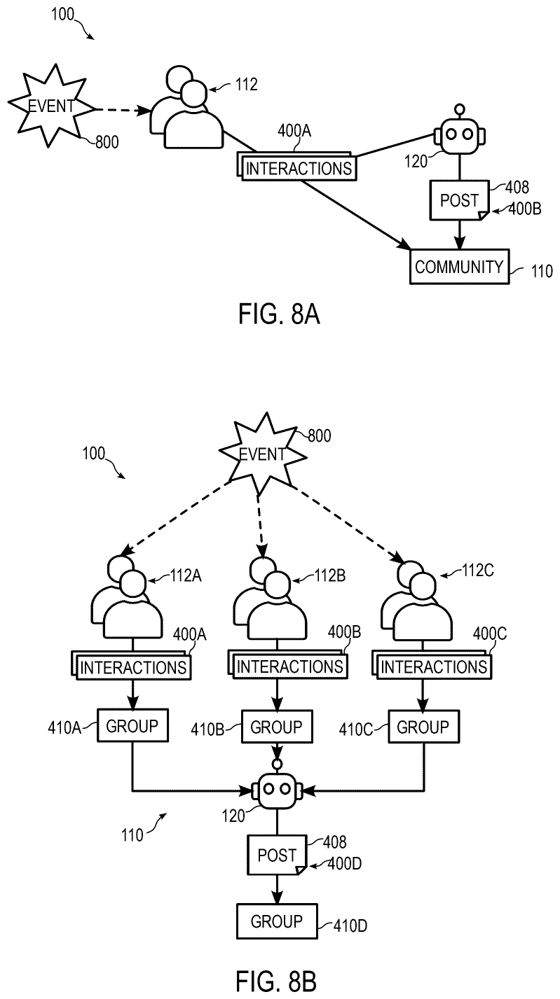

FIG. 6 is a simplified block diagram illustrating an example configuration in AI bot application 100, according to various embodiments. Community 110 may include more than one group 410, say 410a, 410b and 410c. In the example shown, community 110, including all of group 410a-410c, is monitored by a single instance of AI bot 120. The single instance of AI bot 120 may act differently with different ones of group 410 based on corresponding rules 126.

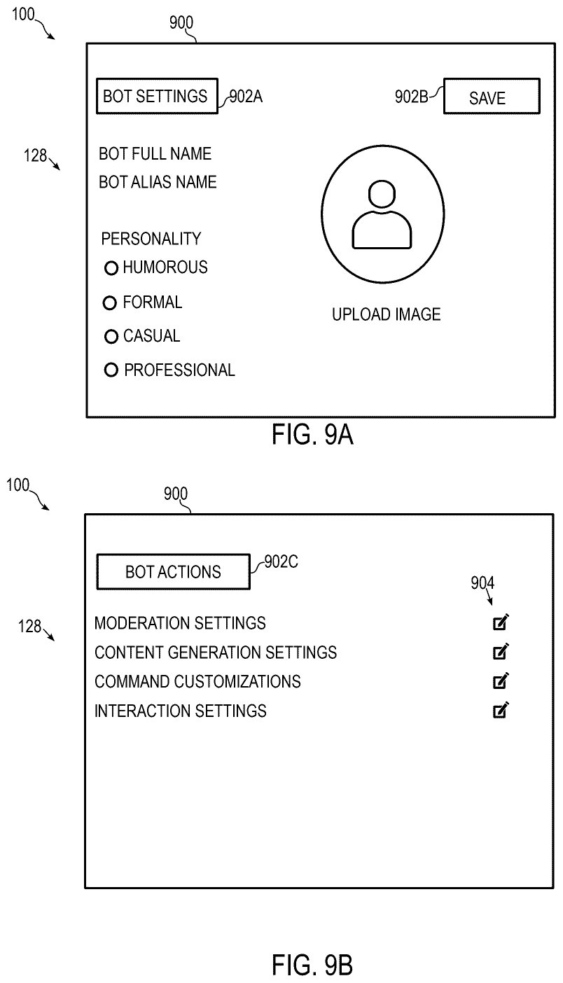

FIG. 7 is a simplified block diagram illustrating an example configuration in AI bot application 100, according to various embodiments. Community 110 may include more than one group 410, say 410a, 410b and 410c. In the example shown, some of group 410, for example, 410a and 410b are monitored by different instances of AI bot 120, for example, AI bot 120a and AI bot 120b, respectively. Other ones of group 410, for example, group 410b and 410c are monitored by a common instance of AI bot 120, i.e., 120b. Each instance of AI bot 120 may have separate bot settings 128, for example, different names, personalities, etc. and may also have different rules 126 for actions. The common instance of AI bot 120 may also act differently with different ones of group 410 based on corresponding rules 126.

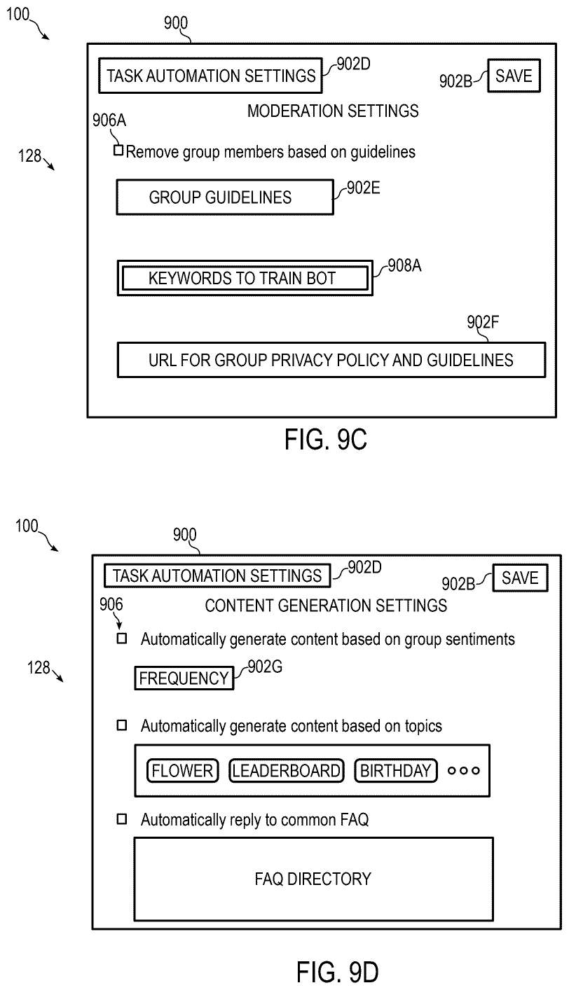

FIGS. 8A-8B are simplified block diagrams illustrating example details of AI bot application 100, according to various embodiments. As shown in FIG. 8A, an event 800 may elicit various descriptions and responses in interactions 400a by community members 112 in community 110. Interactions 400a may be monitored and analyzed in real time by AI bot 120, which may then create post 408 (e.g., news article) about event 800 based on the analysis and publish post 408 in real time in community 110 (e.g., in a news outlet). In the context of the embodiments described herein, “real time” refers to the ability of AI bot 120 to process interactions 400a and respond thereto substantially immediately as they occur, without any noticeable delay to an average human user. AI bot application 100 may provide instantaneous feedback or results, for example, publishing post 408, often within milliseconds or microseconds in some embodiments. In various embodiments, such real time processing allows AI bot 120 to react to interactions 400a as soon as they happen, without waiting for batch processing or scheduled updates. In some embodiments, post 408 may be reviewed and approved by a human administrator before being posted publicly.

In various embodiments, AI bot 120 may analyze interactions 400a for a sentiment trend (e.g., positive trend, negative trend or neutral trend) and responsive to the identified sentiment trend, compose post 408 with text and images based on semantic analysis of interactions 400a in a tone corresponding to the identified semantic trend. For example, if the identified semantic trend is positive, post 408 may have an upbeat tone; if the identified semantic trend is negative, post 408 may have a sad tone; and if the identified semantic trend is neutral, post 408 may have neither an upbeat tone nor a sad tone. The tone of post 408 may be tailored by suitable use of sentence structure, word choice, multimedia content, and semantic content, in view of the unique culture, theme, focus, membership demographic, emotional content, language patterns, etc. as derived at least from community data 114, member data 116, and rules 126. The semantic analysis may include determining meaning and context of interactions 400a in view of preconfigured rules 126 (e.g., including community guidelines 130, group guidelines 132 and bot settings 128), community data 114, and member data 116.

Semantic analysis may identify underlying concepts, relationships, and intents conveyed in interactions 400a. The main themes or topics discussed in interactions 400a may be identified in some examples, including by extracting key concepts and ideas to grasp the overarching subject matter, and identifying clusters of words or phrases that occur and their frequencies; etc. Entities such as people, organizations, locations, dates, etc. may be recognized and categorized in the semantic analysis. The context surrounding interactions 400a, including the respective background, demographic information, etc. of community members 112 as gleaned from member data 116 and/or community data 114 may be considered in the semantic analysis. Opinions, viewpoints, or attitudes expressed within interactions 400a may be extracted in the semantic analysis to determine the stance of corresponding community members 112 towards various topics or entities discussed. The semantic analysis may aim to understand the underlying intent behind each of interactions 400a in some embodiments. In some embodiments, post 408 may comprise text and images scraped from interactions 400a with appropriate permissions; in some other embodiments, post 408 may comprise original text and images based on information gleaned from interactions 400a through the semantic analysis; in yet other embodiments, post 408 may comprise a combination of original content and scraped content.

In some embodiments, AI bot 120 may compose post 408 only when the number of interactions 400a exceeds a preconfigured threshold. This may ensure that AI bot 120 is reacting appropriately to a majority sentiment, or to a matter of interest in community 400, etc. Low levels of engagement may be ignored by AI bot 120 in some such embodiments and no post may be generated accordingly. In other embodiments, identification of a preconfigured keyword may trigger action by AI bot 120, irrespective of the level of engagement, and post 408 may be composed suitably. In yet other embodiments, a combination of topics, keywords and engagement may trigger action by AI bot 120.

Note that although post 408 is shown, AI bot 120 may compose any other type of interaction 400b, including comment 402, review 404 and message 406 appropriately, based on rules 126. In such interaction 400b, the content thereof may depend on the particular type of interaction 400b; for example, review 404 may not include any substantive content; on the other hand, comment 402 and/or message 406 may include content. Such content may comprise text and images scraped from interactions 400a of community members 112 with appropriate permissions; in some other embodiments, comment 402 or message 406 of AI bot 120 may comprise original text and images based on information gleaned from interactions 400a of community members 112 through the semantic analysis; in yet other embodiments, comment 402 or message 406 of AI bot 120 may comprise a combination of original content and scraped content.

In an example scenario, event 800 may be the release of a famous singer's new album. Community members 112 may publish one or more of post 408 and/or send one or more of message 406 as event 800 unfolds in real time, with information about songs in the album, videos of the singer, etc. as anticipation among fans grows. Interactions 400a may be independent of each other in some embodiments, with community members 112 not being aware of each other. In another example embodiment, a subset of community members 112 may be aware of event 800 and may publish interactions 400a about event 800 in community 110 in real time. Various such possibilities are contemplated within the broad scope of the embodiments. AI bot 120 may monitor interactions 400a and determine, based at least on semantic analysis and sentiment analysis, that an impending album release is unfolding, with growing anticipation by fans, etc. AI bot 120 may compile post 408, comprising a news article with text and images from interactions 400a as determined by suitable permissions analysis and publish it in community 110 in real time. As event 800 unfolds further and more of community members 112 join in interactions 400a, AI bot 120 may modify post 408 suitably, adding, correcting, editing, etc. according to the identified sentiment trend and semantic content of interactions 400a. In some example embodiments, all edits to post 408 may be reviewed by a human; in some other example embodiments, only some edits may be reviewed by a human; in yet other embodiments, no human may review post 408. Note that although only one example embodiment is disclosed herein, myriad variations thereof are encompassed within the broad scope of the embodiments.

FIG. 8B shows another example embodiment, in which event 800 may be described variously by community members 112a, 112b, 112c in respective interactions 400a, 400b, 400c published to one or more groups 410a, 410b, 410c in community 110. Interactions 400a-400c may be monitored and analyzed in real time by AI bot 120, which may then create post 408 (e.g., news article) about event 800 and publish post 408 in real time in yet another group 410d (e.g., news outlet). Note that although only one instance of AI bot 120 is shown, one or more of groups 410a-410c may be monitored by separate instances of AI bot 120 in some other embodiments. In some such embodiments, the separate instances may collaborate with each other to create post 408. In yet another embodiment, a “journalist” instance of AI bot 120 may query other “moderator” instances of AI bot 120 to gather relevant interactions 400a-400c and generate post 408. In some such embodiments, the moderator instances of AI bot 120 may alert the journalist instance of AI bot 120 to the unfolding situation in event 800. Various other such possibilities are encompassed in the broad scope of the embodiments herein.

Note that although post 408 is shown, AI bot 120 may compose any other type of interaction 400d, including comment 402, review 404 and message 406 appropriately, based on rules 126. In such interaction 400d, the content thereof may depend on the particular type of interaction 400d; for example, review 404 may not include any substantive content; on the other hand, comment 402 and/or message 406 may include content. Such content may comprise text and images scraped from interactions 400a-400c of community members 112a-112c with appropriate permissions; in some other embodiments, comment 402 or message 406 of AI bot 120 may comprise original text and images based on information gleaned from interactions 400a-400c of community members 112a-112c through the semantic analysis; in yet other embodiments, comment 402 or message 406 of AI bot 120 may comprise a combination of original content and scraped content.

In an example scenario, group 410d may be a news outlet that publishes breaking news. Event 800 may be newsworthy and important to a wide audience; for example, event 800 may be an earthquake in a remote location. Local community members 112a-112c may publish one or more of post 408 and/or send one or more of message 406 in group 410a-410c as event 800 unfolds in real time. Group 410a may be a neighborhood forum and interactions 400a may comprise text and images of ongoing activities in the neighborhood as the earthquake occurs; group 410b may be a nationwide physicians' network and interactions 400b may comprise one or more of message 406 seeking medical help for victims; group 410c may be a state social service provider forum and interactions 400c may comprise one or more of comment 402 about needing blankets and food for survivors in the locality hardest hit by the earthquake; and so on. Interactions 400a-400c may be independent of each other; indeed, community members 112a-112c may not be aware of each other or may not know that other groups 410a-410c exist. Various such possibilities are contemplated within the broad scope of the embodiments.

AI bot 120 may monitor interactions 400a-400c and determine, based at least on sentiment analysis and semantic analysis, that event 800 comprising an earthquake is unfolding in the remote location, that there are victims and survivors, etc. Such determination may be based on the nature of groups 410a-410c; community data 114; member data 116; community guidelines 130 and group guidelines 132; rules 126; selected ones of AI model 136; and such other factors. AI bot 120 may compose post 408, comprising a news article with text and images from interactions 400 and publish it on group 410d in real time. In some embodiments, post 408 may be reviewed and approved by a human administrator before being posted publicly. Group 410d may be a central news outlet, main page, or other prominent site in community 110. As event 800 unfolds further and more of community members 112 join in interactions 400, AI bot 120 may modify post 408 suitably, adding, correcting, editing, etc. according to the identified sentiment trend and semantic content of interactions 400. AI bot 120 may perform significantly better than a live human journalist, or even a journalistic team in such a situation, being able to collect information from tens to millions of interactions 400 on multiple groups 410 spread across diverse locations globally, analyze the information, compose post 408 and publish it in real time, alerting community members 112 to the ongoing crisis. In some example embodiments, all edits to post 408 may be reviewed by a human; in some other example embodiments, only some edits may be reviewed by a human; in yet other embodiments, no human may review post 408. Note that although only one example embodiment is disclosed herein, myriad variations thereof are encompassed within the broad scope of the embodiments.

FIGS. 9A-9F are example details of a user interface 900 to configure AI bot 120 within AI bot application 100, according to some embodiments. In various embodiments, AI bot 120 may be suitably customized according to the unique culture and tone of community 110 or one or more of group 410 therein. Allowing each group admin to create a customized version of AI bot 120 with a distinct personality could make community management more personalized and engaging. This approach may also ensure that AI bot 120 aligns with the unique culture and tone of each group 410 and its admin.

As shown in FIG. 9A, user interface 900 may include a selectable button 902 (e.g., 902a, 902b) for configuring bot settings 128. Selecting button 902a may allow the user to upload an image representative of AI bot 120, a full name, an alias name, and select from among multiple personality choices, such as humorous, formal, casual, and professional. Such settings may enable an “avatar” for AI bot 120 in community 110. The avatar may enable AI bot 120 to appear human to community members 112. Another selectable button 902b may allow the selections to be saved in bot settings 128.

As shown in FIG. 9B, user interface 900 may include button 902c for configuring bot actions. Selecting button 902c may allow the user to configure various bot actions each selectable by clicking (or otherwise selecting) another user interface element such as edit buttons 904. In the example shown, moderation actions, content generation actions, command actions and interaction actions may be configured suitably and stored as bot settings 128. Selecting an appropriate one of edit buttons 904 of FIG. 9B brings up the corresponding one of views shown in FIGS. 9C-9F.

As shown in FIG. 9C, user interface 900 may include button 902d for configuring automatic task settings for AI bot 120. Selecting button 902d may allow the user to configure various moderation settings. In the example shown, bot actions may be configurable by checking or unchecking a checkbox 906a enabling AI bot 120 to remove group members based on community guidelines 130 and group guidelines 132. Additional user interface elements such as buttons 902e and 902f may be provided. Selecting the respective buttons may enable the admin to enter some of group guidelines 132 appropriately and provide a uniform resource locator (URL) for others of group guidelines 132 and/or community guidelines 130. In some embodiments, a text box 908 (e.g., 908a) may be provided to enter keywords 134.

As shown in FIG. 9D, user interface 900 may include button 902d for configuring automatic task settings for AI bot 120. Selecting button 902d may allow the user to configure various content generation settings. Checkboxes 906 allows the admin to configure AI bot 120 to automatically generate content based on group sentiments, topics, and questions. The configurations may enable AI bot 120 to monitor group discussions and analyze the sentiment to determine the overall mood, which triggers automatic post 408 in response to positive, negative, or neutral sentiment trends according to the configuration settings. Selecting button 902g may permit the admin to enter the frequency with which such content be generated. Various topics may be preconfigured in AI bot application 100 and the admin can select from among such preconfigured topics in some embodiments. In other embodiments, the admin may specify any topic of interest, keeping community members 112 informed and engaged with relevant content. In some embodiments, FAQ 416 may be shown in user interface 900 to enable the admin to make a suitable selection of checkbox 906d.

As shown in FIG. 9E, user interface 900 may include button 902d for configuring automatic task settings for AI bot 120. Selecting button 902d may allow the user to configure various comment customizations. Checkboxes 906 allow the admin to configure AI bot 120 to automatically publish review 404 and/or comment 402 on post 408, reply to comment 402, or remove post 408 and/or comment 402 that violates community guidelines 130 (or group guidelines 132). Selecting button 902h may enable the admin to enter community guidelines 130 appropriately. In the example shown, engagement-based action triggers may be provided, in the form of the number of comment 402 or review 404 that post 408 garners. For example, text boxes 908b-908c may enable the admin to enter a maximum number of comments and reviews respectively to generate automatic actions by AI bot 120. Thus, AI bot 120 may be configured to automatically positively review post 408 based on the number of comment 402 or review 404; automatically comment on post 408 that reach a certain level of engagement; automatically reply to comment 402 when a predefined engagement threshold is reached; automatically delete post 408 that exceed a certain number of negative reactions or fail to meet community guidelines 130 based on engagement metrics.

As shown in FIG. 9F, user interface 900 may include button 902d for configuring automatic task settings for AI bot 120. Selecting button 902d may allow the user to configure various interaction settings. In the example shown, the admin can configure a maximum number of post 408, comment 402 and review 404 by AI bot 120 by entering appropriate numbers in text boxes 908.

Various user elements 902-908 facilitate enabling or disabling or otherwise configuring various bot settings 128 of AI bot 120. In some embodiments, additional user interfaces may be provided to select appropriate AI model 136 (e.g., internal, external, specific algorithm, etc.), API 138, and other features of AI bot application 100.

Although the present disclosure has been described in detail with reference to particular arrangements and configurations, these example configurations and arrangements may be changed significantly without departing from the scope of the present disclosure. For example, although the present disclosure has been described with reference to particular network systems such as cloud networks, AI bot application 100 may be applicable to other networks such as LANs. Moreover, although tiered software framework 200 has been illustrated with reference to particular elements and operations that facilitate the software process, these elements, and operations may be replaced by any suitable architecture or process that achieves the intended functionality of AI bot application 100.

### Example Methods

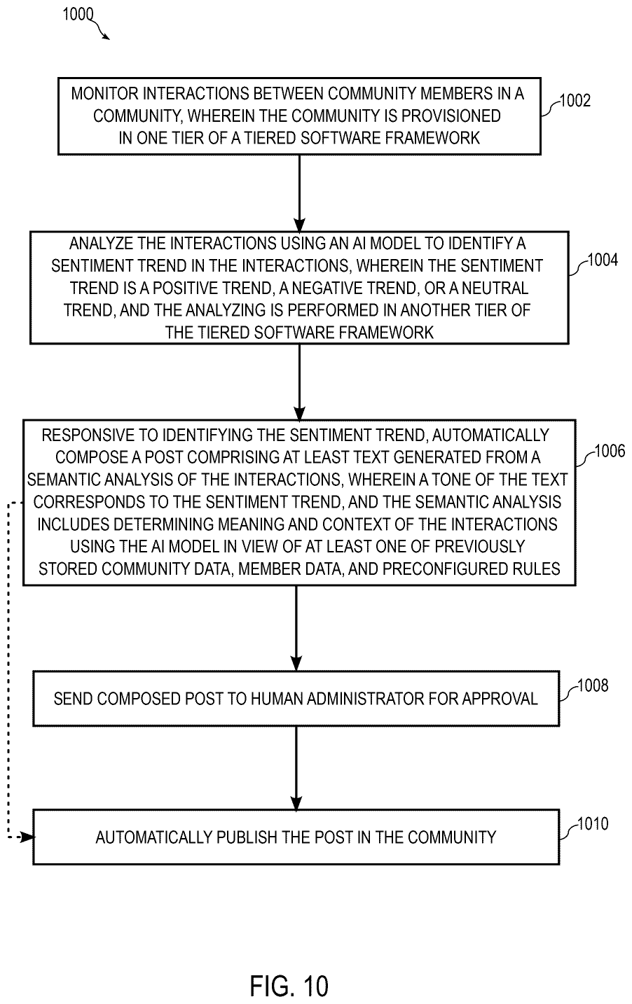

FIG. 10 is a simplified flow diagram illustrating example operations 1000 associated with AI bot application 100, according to some embodiments. At 1002, AI bot 120 may monitor interactions 400a between community members 112 in community 110, which is provisioned in tier 102-2 of tiered software framework 200. At 1004, AI bot 120 may analyze interactions 400a using AI model 136 to identify a sentiment trend therein, the sentiment trend being a positive trend, a negative trend, or a neutral trend. The analyzing may be performed at tier 102-1 of tiered software framework 200. At 1006, responsive to identifying the sentiment trend, AI bot 120 may automatically compose another interaction 400b, say post 408, comprising at least text generated from a semantic analysis of interactions 400a, such that a tone of the text corresponds to the sentiment trend. The semantic analysis includes determining meaning and context of interactions 400a using the AI model 136 in view of at least one of previously stored community data 114, member data 116, and preconfigured rules 126. In various embodiments, previously stored community data 114, member data 116, and preconfigured rules 126 may include and/or indicate permissions to use user-content by AI bot 120. In some embodiments, interaction 400b may comprise user-content from interactions 400a, used with appropriate permissions. In other embodiments, interaction 400b may not contain any user-content from interactions 400a; instead, interaction 400b may comprise a summary, review, or other material relevant to interactions 400a. In some embodiments, preconfigured rules 126 may indicate that AI bot 120 refer to one or more third-party site 412, for example, to verify information, understand a context of interactions 400a, etc., before composing interaction 400b.

At 1008, AI bot 120 may send composed interaction 400b comprising post 408 to a human administrator for approval in some embodiments. At 1010, AI bot 120 may automatically publish interaction 400b comprising post 408 in community 110. In some embodiments, the operations may step directly from 1006 to 1010, skipping the approval from the human administrator. In some such embodiments, interaction 400b may include a notation (e.g., warning, icon, symbol, sign, text, etc.) indicating that it was not reviewed by a human. In other embodiments, substantially all interactions 400b may need approval from the human administrator before being published publicly in community 110.

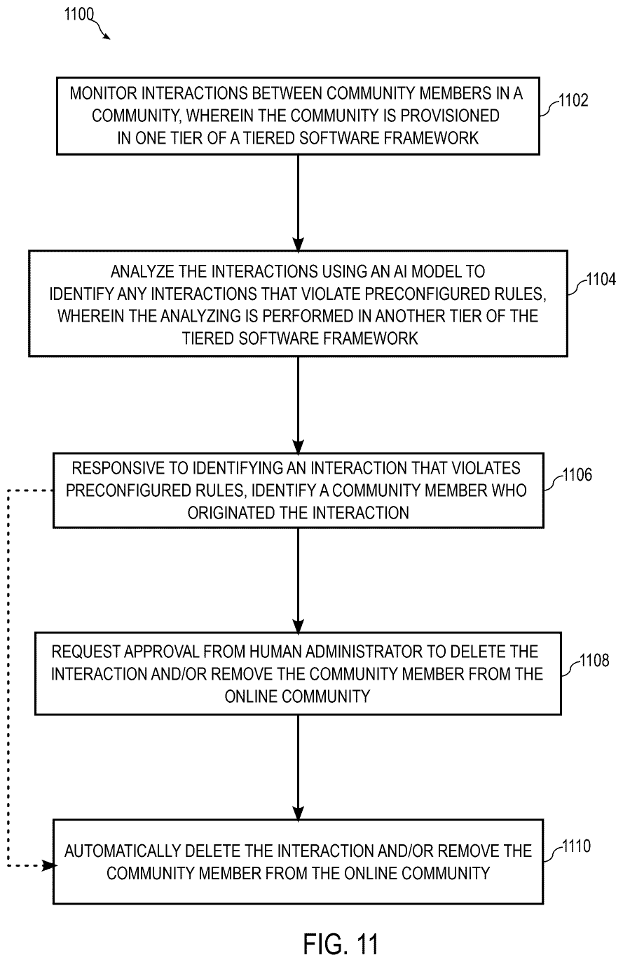

FIG. 11 is a simplified flow diagram illustrating example operations 1100 associated with AI bot application 100, according to some embodiments. At 1102, AI bot may monitor interactions 400 between community members 112 in community 110 provisioned in tier 102-2 of tiered software framework 200. At 1104, AI bot 120 may analyze interactions 400 using AI model 136 to identify any interactions 400a that violate preconfigured rules 126, the analyzing being performed at tier 102-2. At 1106, responsive to identifying interaction 400a that violates at least one of the preconfigured rules 126, identifying a community member 112a who originated interaction 400a. At 1108, AI bot 120 may request approval from a human administrator to delete interaction 400a and/or remove community member 112a from community 110. At 1110, AI bot 120 may automatically delete interaction 400a and/or remove community member 112a from community 110. In some embodiments, the operations may step directly from 1106 to 1110, skipping the approval from the human administrator. In other embodiments, substantially all actions by AI bot 120 may need approval from the human administrator before being performed in community 110.

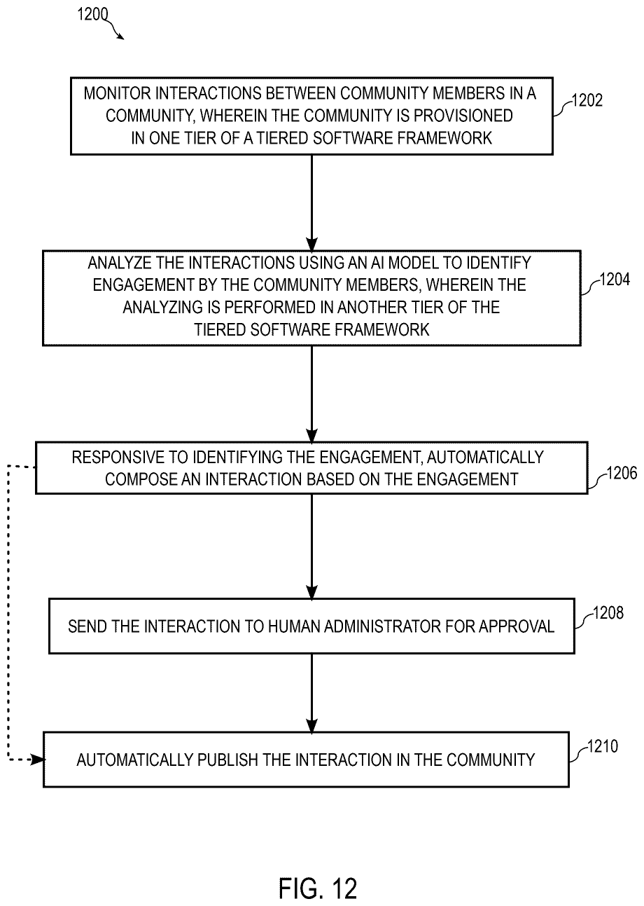

FIG. 12 is a simplified flow diagram illustrating example operations 1200 associated with AI bot application 100, according to some embodiments. At 1202, AI bot may monitor interactions 400a between community members 112 in community 110 provisioned in tier 102-2 of tiered software framework 200. At 1204, AI bot 120 may analyze interactions 400a using AI model 136 to identify engagement by community members 112, the analyzing being performed at tier 102-1. The engagement may be represented by the number of comment 402, review 404, message 406 and/or post 408. The threshold of engagement may be preconfigured in bot settings 128; in other words, when the threshold of engagement is above the preconfigured value, automatic actions by AI bot 120 may be triggered. At 1206, responsive to identifying the engagement, AI bot 120 may automatically compose interaction 400b (e.g., comment 402, review 404, message 406 and/or post 408) based on the identified engagement. At 1208, AI bot 120 may send interaction 400b to a human administrator for approval. At 1210, AI bot 120 may automatically publish interaction 400b in community 110. In some embodiments, the operations may step directly from 1206 to 1210, skipping the approval from the human administrator. In some such embodiments, interaction 400b may include a notation (e.g., warning, icon, symbol, sign, text, etc.) indicating that it was not reviewed by a human. In other embodiments, substantially all interactions 400b may need approval from the human administrator before being published publicly in community 110.

In various embodiments, substantially most operations described in FIGS. 10-12 are performed automatically without human intervention. Although FIGS. 10-12 illustrate various operations performed in a particular order, this is simply illustrative, and the operations discussed herein may be reordered and/or repeated as suitable. Further, additional operations which are not illustrated may also be performed without departing from the scope of the present disclosure. Also, various ones of the operations discussed herein with respect to FIGS. 10-12 may be modified in accordance with the present disclosure to automatically posts 408 or other interaction 400 as disclosed herein. Although various operations are illustrated in FIGS. 10-12 once each, the operations may be repeated as often as desired.

It is important to note that the operations described with reference to the preceding figures illustrate only some of the possible scenarios that may be executed by, or within, AI bot application 100. Some of these operations may be deleted or removed where appropriate, or these steps may be modified or changed considerably without departing from the scope of the discussed concepts. In addition, the timing of these operations may be altered considerably and still achieve the results taught in this disclosure. The preceding operational flows have been offered for purposes of example and discussion.

### SELECT EXAMPLES

Example 1 provides a method for automatically creating posts in a community provisioned in a tiered software framework, the method executed by a software bot, the method comprising: monitoring interactions between community members in the community, the community being provisioned in one tier of the tiered software framework; analyzing the interactions using an AI model to identify a sentiment trend in the interactions, in which the sentiment trend is a positive trend, a negative trend, or a neutral trend, and the analyzing is performed in another tier of the tiered software framework; responsive to identifying the sentiment trend, automatically composing a post comprising at least text generated from a semantic analysis of the interactions, in which a tone of the text corresponds to the sentiment trend, and the semantic analysis includes determining meaning and context of the interactions using the AI model in view of at least one of archived community data, member data, and preconfigured rules; and automatically publishing the post in the community.

Example 2 provides the method of example 1, in which the monitoring, the analyzing, the composing, and the publishing are performed in real time.

Example 3 provides the method of example 2, in which the interactions are relevant to an event occurring in real time, and the post comprises content relevant to the event.

Example 4 provides the method of any one of examples 1-3, further comprising: identifying an interaction that violates one of the preconfigured rules; and deleting the interaction.

Example 5 provides the method of example 4, further comprising: identifying a community member who originated the interaction; and removing the identified community member from the community.

Example 6 provides the method of any one of examples 1-5, in which the post further comprises text and images scraped from the interactions according to permissions from the corresponding community members.

Example 7 provides the method of any one of examples 1-6, in which the software bot has a preconfigured personality, and the tone of the post is according to the personality.

Example 8 provides a non-transitory computer-readable tangible media that includes instructions for execution, which when executed by a processor of a computing device, is operable to perform operations comprising: monitoring interactions between community members in an community provisioned in a tier of a tiered software framework; analyzing the interactions using an AI model to identify a sentiment trend in the interactions, in which: the sentiment trend is a positive trend, a negative trend, or a neutral trend, and the analyzing is performed in another tier of the tiered software framework; responsive to identifying the sentiment trend, automatically composing a post comprising at least text generated from a semantic analysis of the interactions, in which: a tone of the text corresponds to the sentiment trend, and the semantic analysis includes determining meaning and context of the interactions using the AI model in view of at least one of archived community data, member data, and preconfigured rules; and automatically publishing the post in the community.

Example 9 provides the non-transitory computer-readable tangible media of example 8, in which the monitoring, the analyzing, the composing, and the publishing are performed in real time.

Example 10 provides the non-transitory computer-readable tangible media of example 9, in which the interactions are relevant to an event occurring in real time, and the post comprises content relevant to the event.

Example 11 provides the non-transitory computer-readable tangible media of any one of examples 8-10, in which the operations further comprise: identifying an interaction that violates one of the preconfigured rules; and deleting the interaction.

Example 12 provides the non-transitory computer-readable tangible media of example 11, in which the operations further comprise: identifying a community member who originated the interaction; and removing the identified community member from the community.

Example 13 provides the non-transitory computer-readable tangible media of any one of examples 8-12, in which the post further comprises text and images scraped from the interactions according to permissions from the corresponding community members.

Example 14 provides the non-transitory computer-readable tangible media of any one of examples 8-13, in which the tone of the post is according to a preconfigured personality.

Example 15 provides an apparatus comprising: a processing circuitry; a memory storing data; and a communication circuitry, wherein the processing circuitry executes instructions associated with the data, the processing circuitry is coupled to the communication circuitry and the memory, and the processing circuitry and the memory cooperate, such that the apparatus is configured for: monitoring interactions between community members in an community provisioned in a tier of a tiered software framework; analyzing the interactions using an AI model to identify a sentiment trend in the interactions, in which the sentiment trend is a positive trend, a negative trend, or a neutral trend, and the analyzing is performed in another tier of the tiered software framework; responsive to identifying the sentiment trend, automatically composing a post comprising at least text generated from a semantic analysis of the interactions, in which a tone of the text corresponds to the sentiment trend, and the semantic analysis includes determining meaning and context of the interactions using the AI model in view of at least one of archived community data, member data, and preconfigured rules; and automatically publishing the post in the community.

Example 16 provides the apparatus of example 15, in which the monitoring, the analyzing, the composing, and the publishing are performed in real time.

Example 17 provides the apparatus of example 16, in which the interactions are relevant to an event occurring in real time, and the post comprises content relevant to the event.

Example 18 provides the apparatus of any one of examples 15-17, further configured for: identifying an interaction that violates one of the preconfigured rules; and deleting the interaction.

Example 19 provides the apparatus of any one of examples 15-18, in which the post further comprises text and images scraped from the interactions according to permissions from the corresponding community members.

Example 20 provides the apparatus of any one of examples 15-19, in which the tone of the post is according to a preconfigured personality.

The above description of illustrated implementations of the disclosure, including what is described in the abstract, is not intended to be exhaustive or to limit the disclosure to the precise forms disclosed. While specific implementations of, and examples for, the disclosure are described herein for illustrative purposes, various equivalent modifications are possible within the scope of the disclosure, as those skilled in the relevant art will recognize.

1. A method for automatically creating posts in a community provisioned in a tiered software framework, the method executed by a software bot, the method comprising:
monitoring interactions between community members in a community provisioned in a tiered software framework comprising at least a first tier and a second tier, wherein:
the first tier has access to all data in the second tier,
the second tier has no access to any data in the first tier,
the software bot has access to the first tier and the second tier,
the community is provisioned in the second tier;
interfacing with an artificial intelligence (AI) model in the first tier, the AI model being separate from the software bot;
analyzing the interactions using the AI model to identify a sentiment trend in the interactions, wherein:
the AI model has access to all data in the tiered software framework,
the interactions are analyzed by the AI model in the first tier in view of the data accessible to the AI model, and
the sentiment trend is a positive trend, a negative trend, or a neutral trend;
responsive to identifying the sentiment trend, automatically composing a post comprising at least text generated from a semantic analysis of the interactions, wherein:
a tone of the text corresponds to the sentiment trend, and
the semantic analysis includes determining meaning and context of the interactions using the AI model in view of the data accessible to the AI model; and
automatically publishing the post in the community.

2. The method of claim 1, wherein the monitoring, the analyzing, the composing, and the publishing are performed in real time.

3. The method of claim 2, wherein the interactions are relevant to an event occurring in real time, and the post comprises content relevant to the event.

4. The method of claim 1, further comprising:
identifying an interaction that violates one of the preconfigured rules; and
deleting the interaction.

5. The method of claim 4, further comprising:
identifying a community member who originated the interaction; and
removing the identified community member from the community.

6. The method of claim 1, wherein the post further comprises text and images scraped from the interactions according to permissions from the corresponding community members.

7. The method of claim 1, wherein the software bot has a preconfigured personality, and the tone of the post is according to the personality.

8. Non-transitory computer-readable tangible media that includes instructions for execution, which when executed by a processor of a computing device, is operable to perform operations comprising:
monitoring interactions between community members in a community provisioned in a tiered software framework comprising at least a first tier and a second tier, wherein:
the first tier has access to all data in the second tier,
the second tier has no access to any data in the first tier,
the software bot has access to the first tier and the second tier,
the community is provisioned in the second tier;
interfacing with an artificial intelligence (AI) model in the first tier, the AI model being separate from the software bot;
analyzing the interactions using the AI model to identify a sentiment trend in the interactions, wherein:
the AI model has access to all data in the tiered software framework,
the interactions are analyzed by the AI model in the first tier in view of the data accessible to the AI model, and
the sentiment trend is a positive trend, a negative trend, or a neutral trend;
responsive to identifying the sentiment trend, automatically composing a post comprising at least text generated from a semantic analysis of the interactions, wherein:
a tone of the text corresponds to the sentiment trend, and
the semantic analysis includes determining meaning and context of the interactions using the AI model in view of the data accessible to the AI model; and
automatically publishing the post in the community.

9. The non-transitory computer-readable tangible media of claim 8, wherein the monitoring, the analyzing, the composing, and the publishing are performed in real time.

10. The non-transitory computer-readable tangible media of claim 9, wherein the interactions are relevant to an event occurring in real time, and the post comprises content relevant to the event.

11. The non-transitory computer-readable tangible media of claim 8, wherein the operations further comprise:
identifying an interaction that violates one of the preconfigured rules; and
deleting the interaction.

12. The non-transitory computer-readable tangible media of claim 11, wherein the operations further comprise:
identifying a community member who originated the interaction; and
removing the identified community member from the community.

13. The non-transitory computer-readable tangible media of claim 8, wherein the post further comprises text and images scraped from the interactions according to permissions from the corresponding community members.

14. The non-transitory computer-readable tangible media of claim 8, wherein the tone of the post is according to a preconfigured personality.

15. An apparatus comprising:
a processing circuitry;
a memory storing data; and
a communication circuitry, wherein the processing circuitry executes instructions associated with the data, the processing circuitry is coupled to the communication circuitry and the memory, and the processing circuitry and the memory cooperate, such that the apparatus is configured for:
monitoring interactions between community members in a community provisioned in a tiered software framework comprising at least a first tier and a second tier, wherein:
the first tier has access to all data in the second tier,
the second tier has no access to any data in the first tier,
the software bot has access to the first tier and the second tier,
the community is provisioned in the second tier;
interfacing with an artificial intelligence (AI) model in the first tier, the AI model being separate from the software bot;
analyzing the interactions using the AI model to identify a sentiment trend in the interactions, wherein:
the AI model has access to all data in the tiered software framework,
the interactions are analyzed by the AI model in the first tier in view of the data accessible to the AI model, and
the sentiment trend is a positive trend, a negative trend, or a neutral trend;
responsive to identifying the sentiment trend, automatically composing a post comprising at least text generated from a semantic analysis of the interactions, wherein:
a tone of the text corresponds to the sentiment trend, and
the semantic analysis includes determining meaning and context of the interactions using the AI model in view of the data accessible to the AI model; and
automatically publishing the post in the community.

16. The apparatus of claim 15, wherein the monitoring, the analyzing, the composing, and the publishing are performed in real time.

17. The apparatus of claim 16, wherein the interactions are relevant to an event occurring in real time, and the post comprises content relevant to the event.

18. The apparatus of claim 15, further configured for:
identifying an interaction that violates one of the preconfigured rules; and
deleting the interaction.

19. The apparatus of claim 15, wherein the post further comprises text and images scraped from the interactions according to permissions from the corresponding community members.

20. The apparatus of claim 15, wherein the tone of the post is according to a preconfigured personality.
